(19) United States
(12) Patent Application Publication
(10) Pub. No.: US 2021/0182343 A1
(43) Pub. Date: Jun. 17, 2021

(54) Scalable and Resource-Efficient Extraction of Data from Network-Accessible Documents

(71) Applicant: Microsoft Technology Licensing, LLC, Redmond, WA (US)

(72) Inventors: Ziliu LI, Sammamish, WA (US); Junaid AHMED, Bellevue, WA (US); Arnold OVERWIJK, Redmond, WA (US)

(21) Appl. No.: 16/713,515

(22) Filed: Dec. 13, 2019

(51) Int. Cl. G06F 16/93; G06F 16/955; G06F 16/901; G06F 16/958; G06F 40/143; G06F 40/205; G06K 9/62

(52) U.S. Cl. CPC G06F 16/93; G06F 16/955; G06F 16/9027; G06K 9/6256; G06F 40/143; G06F 40/205; G06F 16/986

(57) ABSTRACT

A technique is described herein for processing network-accessible documents in a scalable and resource-efficient manner. A model-generating process provided by the technique includes three-phases. A first phase generates a set of sample documents associated with a particular class of documents, a second phase applies labels to the sample documents to produce a set of labeled documents, and a third phase generates at least one data-extraction model based on the set of labeled documents. The data-extraction model includes data-extracting logic for extracting at least one specified data item from new documents that match the class of documents. In a data-extracting process, the technique identifies a data-extraction model that applies to the new document and then applies that model.

### BACKGROUND

Various computer-implemented tools exist for extracting data from network-accessible documents (e.g., Internet-accessible web pages). These tools, however, suffer from various shortcomings specified herein.

### SUMMARY

A technique is described herein for processing markup-language network-accessible documents obtained from a wide-area network (e.g., the Internet). In a model-generating process, the technique provides a set of sample documents that match a filter pattern. These sample documents are associated with a particular class of documents. The technique then uses a machine-trained labeling model to apply labels to the set of sample documents, to produce a set of labeled documents. Each label added to a given sample document identifies a type of data item that is present in the sample document and a location of the data item in the sample document. The technique then generates a data-extraction model based on the set of labeled documents by identifying at least one pattern in the set of labeled documents that satisfies a prescribed statistical condition. The data-extraction model includes data-extracting logic for extracting at least one specified data item from new documents that match the class of documents. The technique can perform the above-summarized model-generating process for at least one other class of network-accessible documents, to overall provide plural data-extraction models associated with respective classes of network-accessible documents.

Note that the process of generating the data-extraction models leverages and learns from the knowledge imparted by the labeled documents produced by the machine-trained labeling model. For this reason, the machine-trained labeling model (used in the labeling process) and the process of generating the data-extraction models can be said to have a teacher-student relationship.

In a data-extracting process, the technique receives a new document. The technique then identifies a data-extraction model that applies to the new document. The technique then uses the identified data-extraction model to extract one or more data items from the new document.

In one implementation, the technique can operate in a fully automated manner or at least a partially-automated manner. This characteristic eliminates or reduces the need for a developer or other individual to manually generate data-extraction rules for different kinds of documents. This characteristic also enables the technique to quickly adapt to the discovery of new kinds of documents and the modification of existing kinds of documents.

According to another advantage, the data-extraction models produced by the technique are individually less computation-intensive compared to the machine-trained labeling model. This enables the data-extraction models to individually consume fewer computing resources than the machine-trained labeling model, and potentially provide their results in less time compared to the machine-trained labeling model. This characteristic ultimately allows the technique to quickly mine data items from a relatively large number of documents in a resource-efficient manner, potentially on the scale of the entire World Wide Web. In other words, the technique provides a highly scalable solution to the task of data mining.

Further note that, while the data-extraction models are individually less data-intensive compared to the machine-trained labeling model used to produce the labels, they still incorporate the knowledge imparted by the machine-trained labeling model. This means that the data-extraction models will provide accurate results. The data-extraction models also provide accurate results because they are more sharply focused on extracting data from specific respective classes of documents compared to the more general-purpose machine-trained labeling model used in the labeling process.

The above-summarized technique can be manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative computing environment for processing network-accessible documents.

FIG. 2 shows an illustrative markup-language document (e.g., an HTML document) that can be processed by the computing environment of FIG. 1.

FIG. 3 shows an illustrative data-extraction model produced by the computing environment of FIG. 1.

FIG. 4 shows computing equipment that can be used to implement aspects of the computing environment of FIG. 1.

FIG. 5 shows an example of the operation of the computing environment of FIG. 1.

FIG. 6 shows one implementation of a labeling component, which is an element of the computing environment of FIG. 1.

FIG. 7 shows one implementation of a model-generating component, which is another element of the computing environment of FIG. 1.

FIGS. 8 and 9 together show an overview of a model-generating process performed by the computing environment of FIG. 1.

FIG. 10 shows an overview of a data-extracting process performed by the computing environment of FIG. 1.

FIG. 11 shows an illustrative type of computing device that can be used to implement any aspect of the features shown in the foregoing drawings.

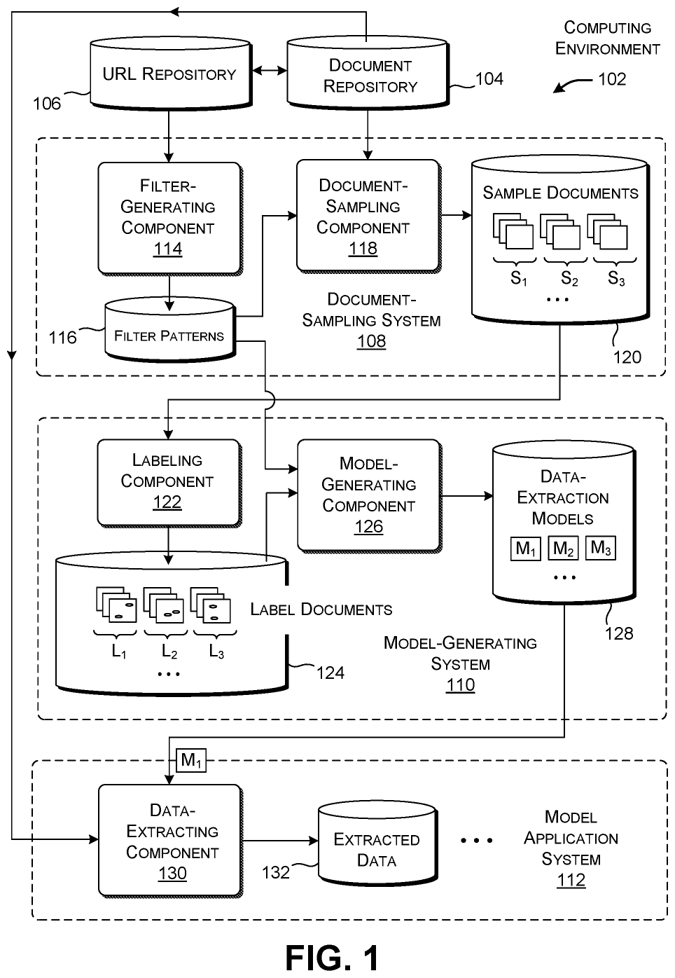

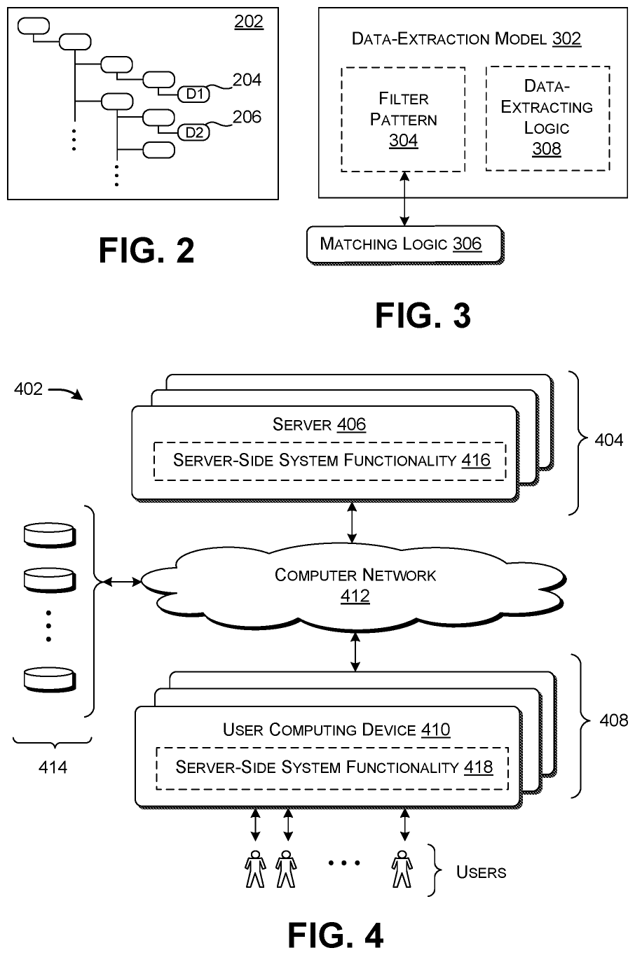

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes a computing environment for extracting data from network-accessible documents. Section B sets forth illustrative methods that explain the operation of the computing environment of Section A. And Section C describes an illustrative kind of computing device that can be used to implement any aspect of the features described in Sections A and B.

As a preliminary matter, the term “hardware logic circuitry” corresponds to a processing mechanism that includes one or more hardware processors (e.g., CPUs, GPUs, etc.) that execute machine-readable instructions stored in a memory, and/or one or more other hardware logic units (e.g., FPGAs) that perform operations using a task-specific collection of fixed and/or programmable logic gates. Section C provides additional information regarding one implementation of the hardware logic circuitry. In some contexts, each of the terms “component,” “engine,” and “tool” refers to a part of the hardware logic circuitry that performs a particular function.

In one case, the illustrated separation of various parts in the figures into distinct units may reflect the use of corresponding distinct physical and tangible parts in an actual implementation. Alternatively, or in addition, any single part illustrated in the figures may be implemented by plural actual physical parts. Alternatively, or in addition, the depiction of any two or more separate parts in the figures may reflect different functions performed by a single actual physical part.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). In one implementation, the blocks shown in the flowcharts that pertain to processing-related functions can be implemented by the hardware logic circuitry described in Section C, which, in turn, can be implemented by one or more hardware processors and/or other logic units that include a task-specific collection of logic gates.

As to terminology, the phrase “configured to” encompasses various physical and tangible mechanisms for performing an identified operation. The mechanisms can be configured to perform an operation using the hardware logic circuitry of Section C. The term “logic” likewise encompasses various physical and tangible mechanisms for performing a task. For instance, each processing-related operation illustrated in the flowcharts corresponds to a logic component for performing that operation. A logic component can perform its operation using the hardware logic circuitry of Section C. When implemented by computing equipment, a logic component represents an electrical element that is a physical part of the computing system, in whatever manner implemented.

Any of the storage resources described herein, or any combination of the storage resources, may be regarded as a computer-readable medium. In many cases, a computer-readable medium represents some form of physical and tangible entity. The term computer-readable medium also encompasses propagated signals, e.g., transmitted or received via a physical conduit and/or air or other wireless medium, etc. However, the specific term “computer-readable storage medium” expressly excludes propagated signals per se, while including all other forms of computer-readable media.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Further, the term “plurality” refers to two or more items, and does not necessarily imply “all” items of a particular kind, unless otherwise explicitly specified. Unless otherwise noted, the descriptors “first,” “second,” “third,” etc. are used to distinguish among different items, and do not imply an ordering among items. Finally, the terms “exemplary” or “illustrative” refer to one implementation among potentially many implementations.

A. Illustrative Computing Environment

FIG. 1 shows an illustrative computing environment 102 for processing network-accessible documents. In one implementation, the network-accessible documents correspond to web pages accessible via a wide area network, such as the Internet. In one implementation, the web pages are expressed in a markup language, such as the HyperText Markup Language (HTML). Other implementations can apply the principles described herein with respect to other kinds documents (e.g., other than, or in addition to, HTML documents).

FIG. 1 shows a document repository 104 for storing the network-accessible documents. In one implementation, the document repository 104 generally represents the distributed resources provided by the Internet. Alternatively, or in addition, the document repository 104 may represent one or more central data stores that provide a collection of network-accessible documents that have been previously harvested from other sources.

FIG. 1 shows another repository 106 for storing identifiers associated with the network-accessible documents. In one implementation, the identifiers correspond to Uniform Resource Locators (URLs) associated with the network-accessible documents, and the URL repository 106 itself corresponds to an index provided at a single location or distributed over two or more locations. Other implementations can apply the principles described herein with respect to other types of identifiers (e.g., other than, or in addition to, URLs). Alternatively, or in addition, other implementations can include a single repository for storing both URLs and the documents associated therewith.

From a high-level perspective, the computing environment 102 extracts data from the network-accessible documents in a labor-efficient, resource-efficient, accurate, and scalable manner. The computing environment 102 accomplishes this goal using three main systems (108, 110, 112). A document-sampling system 108 produces plural sets (S₁, S₂, S₃, . . . ) of sample documents, selected from the document repository 104. A model-generating system 110 generates plural data-extraction models (M₁, M₂, M₃, . . . ) (“models” for brevity) for use in extracting data items from network-accessible documents. And a model application system 112 uses the models to extract data items from the network-accessible documents. As used herein, a “data item” refers to any piece of data contained in a network-accessible document. For example, a data item in a web page that describes a movie might describe the director of the movie. Another data item may describe the release date of the movie, and so on. Each of the above-described systems will be described below in turn.

Starting with the document-sampling system 108, a filter-generating component 114 can produce plural filter patterns that it subsequently uses to extract sample documents from the document repository 104. For example, assume that a developer wishes to extract sample documents from plural top-level domains, one of which is a movie-related database associated with the top-level domain “MovieArchive.com.” The filter-generating component 114 can provide a first filter pattern “MovieArchive.com/*” that matches all pages associated with the top-level domain “MovieArchieve.com,” where the symbol “*” is a wildcard character that designates any information in a URL that follows the prefix information “MovieArchive.com/.” The filter-generating component 114 can generate a second filter pattern “MovieArchive.com/title/*” that matches all pages in a subdomain that includes pages devoted to different movie titles, and so on. Again, the symbol “*” designates any information in a URL that follows the prefix information “MovieArchive.com/title/.” In one non-limiting implementation, the filter-generating component 114 can express each filter pattern as a regular expression (regex).

More generally, the filter-generating component 114 can generate the filter patterns by sequencing through different top-level domains identified in the URL repository 106 (the top-level domain “MovieArchive.com” being one such domain). Or the filter-generating component 114 can sequence through only certain types of top-level domains that are of interest to a developer in a particular context.

The filter-generating component 114 can also optionally generate one or more filter patterns associated with respective subdomains of a website. More specifically, a website (associated with a top-level domain) can be conceptualized as a data structure that organizes its various domains as a hierarchical tree, where each domain includes one or more pages associated therewith. The filter-generating component 114 generates filter patterns that target different nodes of this tree data structure, which are associated with different respective domains. For instance, the filter-generating component 114 can generate a first filter pattern associated with the root of the tree data structure, plural filter patterns associated with child nodes that directly depend from the root node, and so on. The filter-generating component 114 can then store the filter patterns in a filter data store 116, e.g., as respective regular expressions.

A document-sampling component 118 uses each filter pattern to extract a set of network-accessible documents in the document repository 104 that matches the filter pattern. For example, assume that the document repository has two million web pages that match the filter pattern “MovieArchive.com/*.” The document-sampling component 118 can use this filter pattern to randomly select three hundred of these documents. These are merely illustrative values; more generally, in many cases, the document-sampling component 118 can be said to extract a number p of sample documents from the document repository 104 that match a particular filter pattern, where the document repository 104 contains a total number q of documents that match the filter pattern, and where p<<q.

The document-sampling component 118 stores plural sets (S₁, S₂, S₃, . . . ) of sample documents in a sample data store 120. Each set of sample documents is associated with a particular class of documents that matches a particular filter pattern. In some cases, two sets of sample documents associated with a same top-level domain contain entirely distinct subsets of pages. In other cases, a first set of sample documents from a top-level domain is entirely subsumed by another set of sample documents.

The sample data store 120 may represent a data store that is separate from the document repository 104. Alternatively, the sample data store 120 may store identifiers (e.g., URLs) associated with sample documents in the various sets (S₁, S₂, S₃, . . . ) of sample documents, but not the content of those sample documents themselves; in that case, the model-generating component 126 can extract the content of the sample documents from the document repository 104.

Now referring to the model-generating system 110, a labeling component 122 applies labels to different parts of the sample documents stored in or otherwise identified in the sample data store 120. The labeling component 122 can perform this task by annotating each sample document with one or more labels. Each label identifies: (1) a particular kind of data item that is present in the sample document; and (2) the location at which the data item appears in the sample document. For example, with respect to the top-level domain “MovieArhive.com,” the labeling comment 122 can add a label to a sample document that marks a director field in the sample document (that is, which provides the name of the director of a movie). The label can include a code that identifies the label as pertaining to a director field. The labeling component 122 can mark the location of the director field by placing the label in prescribed proximity to the director field, e.g., either before or after a node associated with the director field. Alternatively, or in addition, the labeling component 122 can describe the location of the director field by including label information anywhere in the sample document that identifies the type of the data item (here, a director field) and that describes it location. After this labeling operation, the labeling component 122 stores a plurality of sets of labeled documents (L₁, L₂, L₃, . . . ) in a labeled-document data store 124.

The labeling component 122 can also add labels that identify other features of a sampled document, that is, in addition to, or instead of, data items. For example, the labeling component 122 can add a label that identifies markup content that describes a particular kind of user interface feature, such as a particular kind of user interface control element (e.g., a search box, scroll bar, etc.).

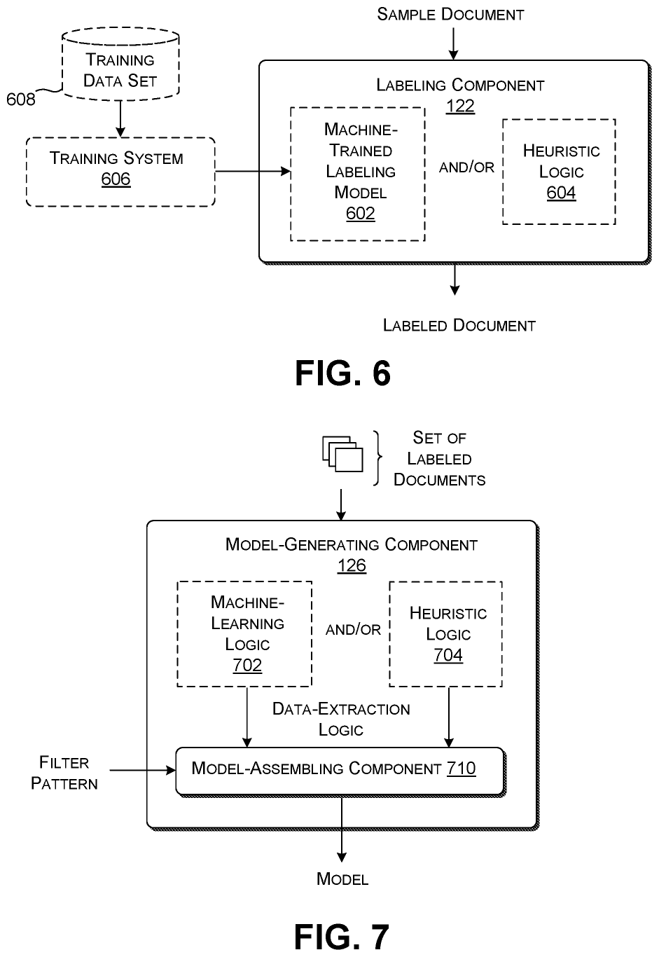

As will be described more fully below in connection with the explanation of FIG. 6, the labeling component 122 can perform the above-summarized labeling task using a machine-trained labeling model and/or heuristic logic. From a high-level perspective, the labeling component 122 can determine the semantic identity of an element under consideration within a sample document based on the information regarding the element itself, as well as information regarding the items that occur before and/or after the element under consideration.

A model-generating component 126 produces at least one data-extraction model M for each set of labeled documents. The model includes data-extracting logic that, when applied, extracts one or more particular types of data items (and/or one or more other types of document features) from a new document. As used herein, a new document means a document that was not used to generate the model itself. For example, in the context of the “MovieArchieve.com” top-level domain, the model-generating component 126 may generate a rule to extract a data item that describes the director of a movie from a markup-language document associated with this top-level domain. The model-generating component 126 stores the models (M₁, M₂, M₃, . . . ) that it generates in a model data store 128.

As will be described more fully below in connection with the explanation of FIG. 7, the model-generating component 126 can perform the above-summarized logic-generating task using machine-trained logic and/or heuristic logic. Generally, the model-generating component 126 attempts to find statistically-significant relationships exhibited by a set of labeled documents. The model-generating component 126 then formulates data-extracting logic based on those relationships. The model-generating component 126 can formulate this logic in various ways, e.g., using an IF-THEN-type rule, an XPath expression (described in the specification “XML Path Language (XPath),” Version 1.0, W3C Recommendation, October 2016), etc., or any combination thereof. Generally, the data-extracting logic operates by finding at least one data item of interest in a new document, and then extracting the identified data item(s).

The model-generating component 126 can generate a confidence score that reflects a level of confidence that it has generated an instance of data-extracting logic that is statistically significant, relative to any environment-specific threshold value or other test that defines what constitutes a statistically significant score. For instance, the model-generating component 126 can compute this score based on a number of labeled documents that exhibit a particular pattern involving a particular kind of data field, normalized by a total number of labeled documents that include this kind of data field. The model-generating component 126 can discard an instance of data-extracting logic if its confidence score is below the prescribed threshold value.

In addition, or alternatively, the model-generating component 126 can apply an instance of data-extracting logic to new documents (meaning documents that were not used to generate the data-extracting logic). The model-generating component 126 can count the number of times that the data-extracting logic is successful in extracting an intended data item (or items), relative to a total number of new documents that have been considered that are presumed to contain the data item (or items) of interest. If this count satisfies a prescribed threshold value, then the model-generating component 126 can deem this instance of data-extracting logic as statistically significant. If not, the model-generating component 126 can discard the proposed data-extracting logic.

In some cases, the model-generating component 126 may discover that plural different instances of data-extracting logic provide viable ways of extracting a data item of interest from documents. In this case, the model-generating component 126 can select at least one of these instances based on any factor(s), such as by selecting the instance having the highest confidence score, and/or the instance that makes most efficient use of computing resources, etc., or any combination thereof.

In general, the model-generating component 126 leverages and learns from the knowledge imparted by the labeled documents produced by the labeling component 122. For this reason, the labeling component 122 and the model-generating component 126 can be said to have a teacher-student relationship. In other words, the labeling component 122 can be said to transfer its learning to the model-generating component 126. But note that, while the data-extraction models produced by the model-generating component 126 learn from the labeled documents produced by the labeling component 122, they are individually less complex and data-intensive compared to the machine-trained labeling model used by the labeling component 122. As described more fully below, this characteristic allows the data-extraction models to extract data from a relatively large number of documents in a time-efficient and resource-efficient manner. In other words, this characteristic contributes to the highly scalable nature of the solution described herein.

With respect to the model application system 112, a data-extracting component 130 applies the models in the model data store 128. In operation, the data-extracting component 130 receives a new document. As explained above, a new document corresponds to a document pulled from the document repository 104 that was not used to generate any of the models. As a first task, the data-extracting component 130 attempts to find a model that is appropriate for the particular kind of new document that is under consideration. The data-extracting component 130 can perform this task using matching logic (not shown in FIG. 1). The matching logic determines which filter pattern (or filter patterns) match(es) the URL associated with the new document. Each such filter pattern is associated with a particular model in the model data store 128. The matching logic then selects the model that is associated with the matching filter pattern(es). In FIG. 1, assume that the selected model is M₁. To facilitate explanation, it will henceforth be assumed that the data-extracting component 130 selects and applies a single model to process each new document.

The matching logic can consult a single data store that provides the filter patterns associated with the different models. Or each individual model can include a signature that reveals its own filter pattern. In the latter scenario, the matching logic can compare the URL associated with an incoming new document with the signature of each model. The matching logic can be implemented as a subcomponent of the data-extracting component 130, or as an “external” component that the data-extracting component 130 consults.

In one implementation, the matching component can use the same filter patterns as the document-sampling component 118, e.g., corresponding to the filter patterns in the filter data store 116. In another implementation, the matching component can use different filter patterns compared to those used by the document-sampling component 118. For example, the model-generating component 126 may discover that the top-level domain “MovieArchive.com” organizes information in substantially the same manner as another top-level domain, e.g., “FilmWarehouse.com.” For instance, these two top-level domains may include substantially the same semantic content, and exhibit substantially the same organization of this semantic content. If so, the model-generating system 110 can produce a new filter pattern that can be used to identify any page associated with either of these two top-level domains. In one case, the model-generating system 110 can perform this task by forming a disjunction of the filter patterns in the filter data store 116 associated with the two top-level domains (“MovieArchive.com” and “FilmWarehouse.com”). Different implementations can define what is considered substantially similar. For example, an implementation can identify two top-level domains as being substantially similar when the data-extracting logic associated with these two sites overlaps by at least a prescribed amount.

As a second function, the data-extracting component 130 can apply a selected model to extract one or more types of data items (and/or other document features) from the new document. For example, assume that a model includes data-extracting logic that is configured to extract the name of a director of an HTML page associated with the top-level domain “MovieArchive.com.” The data-extracting component 130 uses the data-extracting logic to locate the director information in the new document and then extract it. The data-extracting component 130 can store the extracted data items in a data store 132.

The model application system 112 can include yet other components that make use of the models in the model data store 128. For example, although not shown, the model application system 112 can include a downstream application component that performs analysis on the data items in the data store 132.

The computing environment 102 as a whole has various benefits. According to one benefit, the computing environment 102 performs its task in a fully automated manner or at least partially automated manner. This factor eliminates the need for a human developer to manually craft data extraction rules for different kinds of web pages. This factor also enables the computing environment 102 to quickly adapt to the discovery of new kinds of web pages (e.g., associated with a newly introduced top-level domain), and/or the modification of existing web pages (associated with existing top-level domains).

In addition, the data-extraction models produced by the model-generating system 110 can be expected to consume fewer computing resources compared to some alternative approaches. For instance, consider an alternative approach that uses a single engine to handle all aspects of the logic-generating process, with respect to all documents (e.g., irrespective of the top-level domains associated with the input documents). This kind of engine can be characterized as a global end-to-end model. For example, this kind of engine can correspond to an end-to-end machine-trained model. In whatever manner this engine is implemented, it can be expected to be complex. For the same reason, this engine can be expected to consume a significant amount of computing resources to train and to run once it is trained. The computing resources include processing and/or memory resources.

In contrast, the computing environment 102 produces extraction logic that can take the form of a collection of discrete rules that are applicable to different respective classes of documents (e.g., different websites). This enables the model application system 112 to run the data-extracting logic in a resource-efficient manner and time-efficient manner, compared to logic used (for instance) in a complex end-to-end neural network or the like. This characteristic ultimately allows the computing environment to quickly mine data items from a relatively large number of documents, potentially on the scale of the entire World Wide Web. In other words, the computing environment 102 provides a highly scalable solution to the task of data mining.

Further still, the computing environment 102 develops models that specifically target particular classes of documents. This factor can potentially improve the accuracy with which the computing environment 102 identifies and extracts data items from documents (again, with reference to a global end-to-end engine). This is because each instance of data-extracting logic is devoted to a task having reduced scope and complexity compared to a global end-to-end engine, and for that reason, may be less subject to error compared to a global end-to-end engine.

The above-noted potential advantages are cited by way of example, not limitation. The computing environment 102 can offer yet other benefits in particular contexts.

FIG. 2 shows an illustrative markup-language document 202 that can be processed by the computing environment 102 of FIG. 1. In one implementation, the markup-language document 202 corresponds to a static HTML document. In that case, the markup-language document 202 includes a plurality of elements arranged in a tree data structure. In some cases, the markup-language document 202 uses tag-pairs to identify different types of elements, as in the example <p class=“paragraph”> This movie runs just over 2 hrs.</p>. The information <p class=“paragraph”> corresponds to a start tag associated with the element. Within the start tag, “class” is an attribute name, and “paragraph” is an attribute value. The text “This movie runs just over 2 hrs.” corresponds to the content associated with the element, and </p> corresponds to an end tag associated with the element. The text “This movie runs just over 2 hrs.” may also be considered a data item.

In other cases, the sample documents can correspond to downstream representations of network-accessible documents produced by browser functionality, e.g., provided by a client-side browser application or a simulation thereof. For example, the sample documents can correspond to Document Object Model (DOM) representations that the browser functionality produces based on the received HTML documents. In other cases, the sample documents can correspond to render trees produced by the browser functionality. A render tree combines a DOM representation of an HTML document with a Cascading Style Sheet Object Model (CSSOM) associated with the HTML document. The CSSOM, in turn, incorporates style information specified by Cascading Style Sheets (CSSs) identified in the HTML document. In yet other cases, the sample documents can correspond to respective custom representations of the identified HTML documents. These custom representations may be unique to the computing environment 102 of FIG. 1, and not necessarily produced by a browser application.

In the above cases, the model-generating system 110 operates on sample documents in the form of DOMs, render trees, or custom object-model representations. In yet other cases, the model-generating system 110 can perform its operations based on sample documents expressed in plural forms, e.g., by operating on both the static HTML and the render tree associated with each sample document. However, to facilitate explanation, the remaining explanation will assume that the model-generating system 110 operates on sample documents in the form of different sets of HTML documents.

Whatever form the markup-language document 202 assumes, FIG. 2 indicates that this markup-language document 202 includes at least two data items (204, 206). For example, in the context of the top-level domain “MovieArchieve.com,” the first data item 204 may identify the title of a movie and the second data item 206 may identify the director of the movie, etc.

FIG. 3 shows an illustrative data-extraction model 302 produced by the computing environment 102 of FIG. 1. Generally, a data-extraction model refers to any logic that performs a data-extraction function. That logic can be produced by any process or combination of processes. In one implementation, the data-extraction model 302 includes at least two parts. A first part specifies a filter pattern 304 associated with the data-extraction model 302. Matching logic 306 determines whether the data-extraction model 302 matches a new document (e.g., a new HTML document) under consideration; it performs this task by determining whether the URL associated with the new document matches the filter pattern 304 (e.g., which can be implemented as a regex expression). In one implementation, the matching logic 306 corresponds to a component of the data-extracting component 130 shown in FIG. 1.

A second part of the data-extraction model 302 specifies data-extracting logic 308. The data-extracting logic 308 includes instructions to be used to access one or more particular types of data items in the new document. As explained above, the data-extracting logic 308 can be implemented in different ways, such as by one or more IF-THEN-type rules, XPath information, etc., or any combination thereof. In the context of FIG. 2, the data-extracting logic 308 provides instructions as to how to navigate through the tree data structure to reach the data items (204, 206) of interest.

FIG. 4 shows computing equipment 402 that can be used to implement aspects of the computing environment 102 of FIG. 1. The computing equipment 402 includes a plurality of servers 404 (including a representative server 406) coupled to a plurality of user computing devices 408 (including a representative user computing device 410) via a computer network 412. The user computing devices 408 can include any types of computing devices, including desktop personal computing devices, laptop computing devices, any type or types of handheld computing devices (e.g., smartphones, tablet-type computing devices, etc.), game consoles, mixed-reality devices, wearable devices, Internet-of-Thing (IoT) devices, and so on, or any combination of thereof. The computer network 412 can correspond to any type of local area network, any type of wide area network (e.g., the Internet), etc., or any combination thereof. The computer network 412 also provides access to any number of data stores 414. These data stores 414 may represent the distributed data repository provided by the Internet and/or one or more centralized data stores that provide documents harvested from other sources.

The functionality of the computing environment 102 can be distributed among the devices shown in FIG. 4 in any manner. FIG. 4 illustrates this point by showing that any server can include any system functionality (e.g., system functionality 416), and by showing that any user computing device can likewise include any system functionality (e.g., system functionality 418). Each instance of the system functionality can implement any aspect(s) of the operations performed by the computing environment 102. For instance, in one implementation, the servers 404 can implement all aspects of the systems (108, 110, 112) that make up the computing environment 102. In another implementation, each local user computing device can implement all aspects of the systems (108, 110, 112). In still another implementation, the servers 404 and the user computing devices 408 can cooperatively implement the functions of the systems (108, 110, 112) in distributed fashion. For instance, the servers 404 can implement the document-sampling system 108 and the model-generating system 110, while each user computing device can implement its own local instantiation of the data-extracting component 130. Still other implementations are possible.

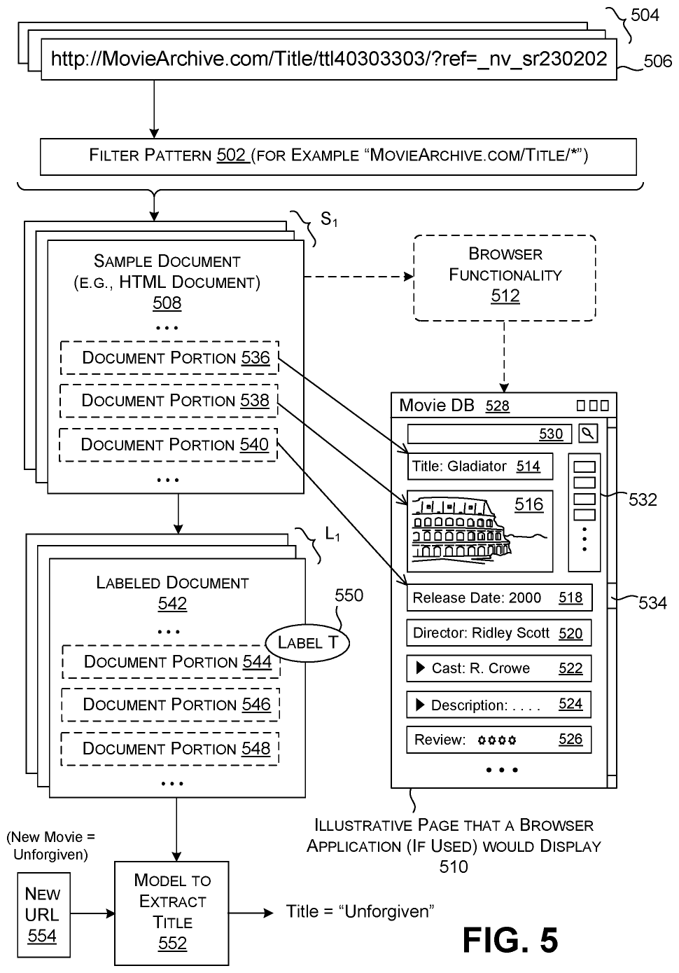

FIG. 5 shows an example of the operation of the computing environment 102 of FIG. 1. This example will be explained by making reference to the components of the computing environment 102 shown in FIG. 1, previously described.

In this example, the computing environment 102 is tasked with the responsibility of generating a model used to extract movie titles from web pages associated with a top-level domain MovieArchive.com. To begin with, assume that the filter-generating component 114 identifies one or more filter patterns associated with this website, including the filter pattern 502 having the illustrative form MovieArchive.com/title/*. This filter pattern 502 matches all pages having URLs having the prefix “MovieArchive.com/title.”

The document-sampling component 118 identifies a collection of URLs 504 that match the filter pattern 502, including the representative URL 506. The document-sampling component 118 then stores a set (S₁) of sample documents that match the filter pattern 502 in the sample data store 120. In many cases, the number of sample documents in the set S₁ is much less than the total number of network-accessible documents in the document repository 104 that match the filter pattern 502.

One representative sample document 508 provides static HTML associated with a particular page 510 in the MovieArchive.com website that describes a particular movie (here, the movie having the title “Gladiator”). If the user activates the URL 506 associated with the sample document 508 using conventional browser functionality 512 provided by a user computing device (not shown), the browser functionality 512 would render the sample document 508 and display it on a display device (not shown), e.g., where it may appear to the user as the illustrative page 510. However, note that the computing environment 102 itself need not render the page 510. FIG. 5 shows the visual appearance of the page 510 only to facilitate an understanding of the sample document 508, which, as said, may correspond to static HTML from which the page 510 is ultimately produced.

Without limitation, this representative page 510 includes various content-related parts, including a title section 514 (that provides the title of the movie), at least one image 516, a release date section 518 (that provides the release date of the move), a director section 520 (that provides the director of the movie), a cast section 522 (that provides the actors and actresses that appear in the movie), a description section 524 (that provides a textual description of the movie), a rating section 526 (that provides a rating score associated with the movie), and so on. Assume that other pages associated with the subdomain “MovieArchive.com/title/” contains the same kind of information and use the same organizational layout as the representative page 510, but are associated with other respective movies. Further assume that all pages in this subdomain include various movie-agnostic features, such as a header 528, a search box 530, a menu 532, a scroll bar 534, and so on.

Different parts of the sample document 508 contain markup content that governs the presentation of different parts of the representative page 510. For example, a document portion 536 governs the presentation of the title section 514, a document portion 538 governs the presentation of the image 516, a document portion 540 governs the presentation of a release date section 518, and so on. Each portion may include one or more elements in an HTML tree data structure.

The labeling component 122 applies labels to the sample documents in the set S₁ of sample documents, to produce a set L₁ of labeled documents. For example, the labeling component 122 produces a representative labeled document 542 that is the labeled counterpart of the sample document 508. The labeled documents includes portions (544, 546, 548) that are label-bearing counterparts of the portions (536, 538, 540) in the sample document 508.

For instance, FIG. 5 generally indicates that the document portion 544 has been tagged with a label 550 that indicates that this portion 544 includes a data item that specifies the title of the movie. For example, the label 550 can include a code that indicates that it pertains to a title. The labeling component 122 may identify the location of the title in any manner, e.g., by placing the label 550 just prior to or just after a node associated with the movie title. Alternatively, or in addition, the labeling component 122 can produce a section of the labeled document 542 devoted to storing label information; the labeling component 122 can then add the label 550 to that section. In that scenario, the label 550 can include a code that identifies it as pertaining to title information. It can also include location information (e.g., XPath information, etc.) that identifies the location of the data item in the labeled document 542 to which it pertains. Still other ways of labeling a sample document are possible.

Next, the model-generating component 126 generates a data-extraction model 552 based on the set L₁ of labeled documents. Assume, in this merely illustrative case, that the goal of model-generating process is to specifically generate a model 552 that is configured to extract titles from new documents. The model-generating component 126 can produce this model 552 by identifying the most prevalent placement of title information within the set L₁ of labeled documents. The model-generating component 126 determines whether this pattern exhibited by the set L₁ of labeled documents is statistically significant. If the pattern is deemed significant, the model-generating component 126 produces a rule that provides instructions that the data-extracting component 130 can leverage to extract title information at the location at which it is expected to be found. Different implementations can define what constitutes a statistically significant pattern in different ways. For example, the model-generating component 126 can generate a data extraction rule if it determines that a prescribed number of labeled pages exhibit a particular placement of title information, relative to a total number of relevant candidate labeled documents that include a title tag. Alternatively, or in addition, the model-generating component 126 can determine whether a proposed pattern successfully extracts title information from a prescribed number of new documents that are known or assumed to include title information.

In a last phase, assume that the data-extracting component 130 receives a new document 554, e.g., corresponding to a web page in the website MovieArchive.com that is associated with another movie. The matching logic 306 (of FIG. 3) first determines the appropriate model that should be used to extract the title from this new document 554. Here, the new document 554 matches the filter pattern 502, which means that the matching logic 306 determines that the model 552 is the appropriate model to use. Next, the data-extracting component 130 leverages the data-extracting logic associated with this model 552 to extract a data item that provides title information, here the title “Unforgiven.”

The model 552 is considered “light” because it is narrowly tailored to extracting one or more particular kinds of data items of interest from a specific domain of interest, compared, for example, to a global end-to-end data extraction engine that is intended to extract data from all domains. For this reason, the computing environment 102 can apply these kinds of models in a time-efficient and resource-efficient manner (compared again to a more complex global data extraction engine).

FIG. 6 shows one implementation of the labeling component 122. As explained above, the labeling component 122 applies labels to sample documents. As also noted above, a label can include a code that describes the kind of data item or other document feature to which it pertains. A label can also identify the location of the data item or other document feature to which it pertains, e.g., based on the placement of the label within the sample document and/or other information (e.g., XPath information) that describes the location of the data item or other document feature.

In one implementation, the labeling component 122 can apply the same label-generating logic to all classes of network-accessible documents. The different classes are associated with different respective sets (S₁, S₂, S₃, . . . ) of sample documents. In another case, the labeling component 122 can apply different instances of label-generating logic that are configured to process different classes of documents. For example, the labeling component 122 can apply logic that is specifically adapted to process documents relating to movie descriptions and reviews, including, but not limited to, documents associated with the above-identified host domain MovieArchive.com. In this implementation, the labeling component 122 can consult a lookup table or other mechanism to determine what kind of label-generating logic should apply to a set of sample documents under consideration. The labeling component 122 can then apply the selected label-generation logic to the set of sample documents.

In one implementation the labeling component 122 can use at least one machine-trained labeling model 602 to identify particular kinds of data items and/or other document features in a sample document. For example, the machine-trained labeling model 602 can use any type of machine-trained classification model to perform this task, including, but not limited to: a Support Vector Machine (SVM) model; a decision tree model; a Deep Neural Network (DNN) model of any type or combinations of types; a logistic regression model; a Conditional Random Fields (CRFs) model; a Hidden Markov Model (HMI), and so on, or any combination thereof. Neural network models include, but are not limited to, fully-connected feed-forward networks, Convolutional Neural Networks (CNNs), Recurrent Neural Networks (RNNs), transformers, etc., and so on.

In one non-limiting approach, the machine-trained labeling model 602 can sequence through the elements in a sample document under consideration and apply a label to each element. In processing an element under consideration in a sample document, the machine-trained labeling model 602 can receive a collection of features that describes the element. For instance, the features can describe the text associated with the element under consideration. The features can also describe the text associated with neighboring elements in the tree data structure associated with the sample document. For example, the features can describe elements in an n-element window that encompasses the element under consideration. In an encoding operation, the machine-trained labeling model 602 can convert the features into a format that is appropriate for further processing, e.g., by converting the features into respective one-hot vectors, etc. The machine-trained labeling model 602 can then operate on the vectors in one or more layers of processing logic. In one implementation, the machine-trained labeling model 602 outputs a numeric result. The machine-trained labeling model 602 can map that numeric result into a particular label (e.g., a director-related label) selected from a predefined label vocabulary that defines a set of possible labels. The machine-trained labeling model 602 can perform this task in any way, such as by consulting a lookup table. The machine-trained labeling model 602 can also generate a confidence score that reflects a level of confidence that the label it has generated is correct.

The machine-trained labeling model 602 can also include one or more machine-trained attention mechanisms. An attention mechanism selectively modifies the weights applied to values in a particular layer of the machine-trained labeling model 602 based on respective degrees to which the values play a role in influencing the output result of the machine-trained labeling model 602. By modifying the values in this manner, the attention mechanism ultimately promotes some feature values over other feature values.

Alternatively, or in addition, the labeling component 122 can use heuristic logic 604 to perform its labeling task. The heuristic logic 604 can include one or more IF-THEN rules, one or more algorithms, etc. For example, the heuristic logic 604 can apply a rule applicable to the top-level domain MovieArchive.com that instructs the labeling component 122 to apply a director label in prescribed proximity to a node in a tree data structure that includes the text “director,” “directed by,” etc.

A training system 606 produces the machine-trained labeling model 602, if used. The training system 606 produces the machine-trained labeling model 602 by iteratively operating on a set of training examples in a data store 608, to satisfy some specified training objective. For example, the training examples may include a set of training documents with labels added thereto, with information that indicates whether each label is correct or incorrect. The training system 606 can produce the machine-trained labeling model 602 by iteratively increasing the likelihood that the model 602 produces correct labels, and/or iteratively decreasing the likelihood that the model 602 produces incorrect labels. It can perform this task using any training technique, such as stochastic gradient descent, etc.

FIG. 7 shows one implementation of the model-generating component 126. Like the labeling component 122, the model-generating component 126 can apply the same logic to all classes of documents, or apply class-specific logic to respective different classes of documents. If the latter case applies, the model-generating component 126 can consult a lookup table or other mechanism to determine what kind of logic to apply to a particular set of labeled documents under consideration. The model-generating component 126 can then apply the selected logic to the set of labeled documents.

Further like the case of the labeling component 122, the model-generating component 126 can perform its operations using a machine-learning logic 702 and/or heuristic logic 704. In one implementation, the machine-learning logic 702 can be configured to detect patterns in a set of labeled documents using any type of learning technique, such as any type of an unsupervised clustering technique. A pattern generally indicates that a particular data item commonly appears at a particular location in a document, given a particular context.

The heuristic logic 704 can use any type of rule-finding algorithm. For example, the heuristic logic 704 can identify those cases in which a particular data item appears in a set of labeled documents at a same particular location, and with respect to a particular context, and with a consistency that satisfies a prescribed statistical condition. For instance, the heuristic logic 704 can identify a number of labeled documents in which a director field appears at a particular place, normalized by a total number of labeled documents in which the director field appears at all. If that measure satisfies a prescribed threshold value, then the heuristic logic 704 can generate data-extracting logic that operates to extract director information from the identified location in which that information is expected to appear. In other implementations, the heuristic logic 704 uses more complex rule-finding logic to discover prevalent patterns, such as by using any type of association rule-learning algorithm (such as the a-priori algorithm).

The heuristic logic 704 can formulate rules having any complexity. For instance, the heuristic logic 704 can discover that many labeled documents identify the staring actor or actress in a film as a topmost entry of a table in a web page within a particular top-level domain, providing that the table has a legend that includes the keywords “cast” or “staring,” etc. The heuristic logic 704 can determine whether the frequency at which this relationship appears exceeds an environment-specific threshold value. If so, the heuristic logic 704 can generate data-extracting logic that leverages this relationship, e.g., by including logic that is configured to extract a first entry of a table having a legend that includes the keywords “cast” or “staring,” etc. In yet other cases, the heuristic logic 704 can incorporate IF-THEN rules. For example, the heuristic logic can indicate that a set of data-extraction rules applies if a particular keyword is detected in a document under consideration, and another set of data-extraction rules applies if another particular keyword appears in the document under consideration.

As noted above, the model-generating component 126 can optionally also assess whether a proposed instance of data-extracting logic is statistically significant by taking into consideration how successful the proposed data-extracting logic is in extracted a data item of interest from new documents. The model-generating component 126 can deem proposed data-extracting logic statistically significant if its level of success in extracting a data item is above a prescribed threshold value.

A model-assembling component 710 can assemble different parts of the model into an integrated whole. For example, the model-assembling component 710 can combine a filter pattern with the generated data-extracting logic. The filter pattern identifies the class of documents to which the model pertains.

B. Illustrative Processes

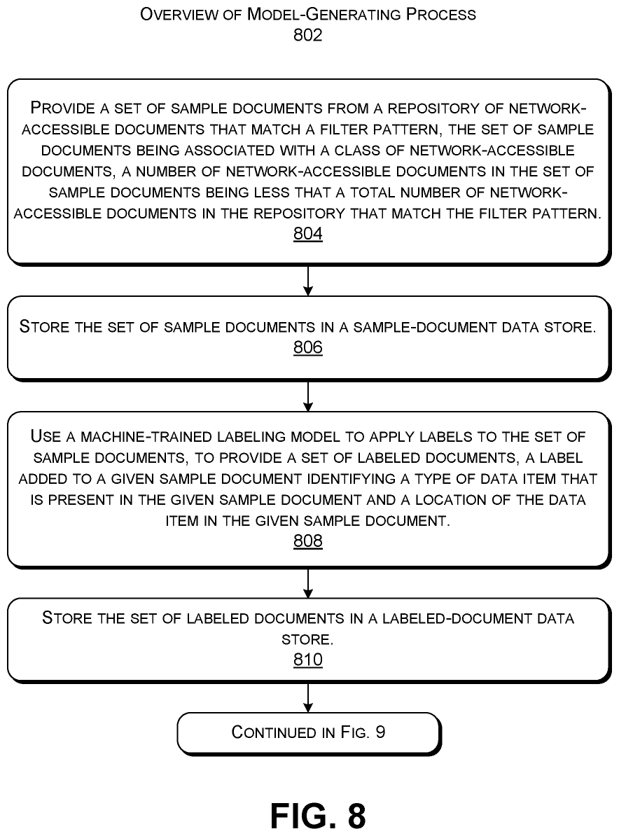

FIGS. 8-10 show processes (802, 1002) that explain the operation of the computing environment 102 of Section A in flowchart form. Since the principles underlying the operation of the computing environment 102 have already been described in Section A, certain operations will be addressed in summary fashion in this section. As noted in the prefatory part of the Detailed Description, each flowchart is expressed as a series of operations performed in a particular order. But the order of these operations is merely representative, and can be varied in any manner.

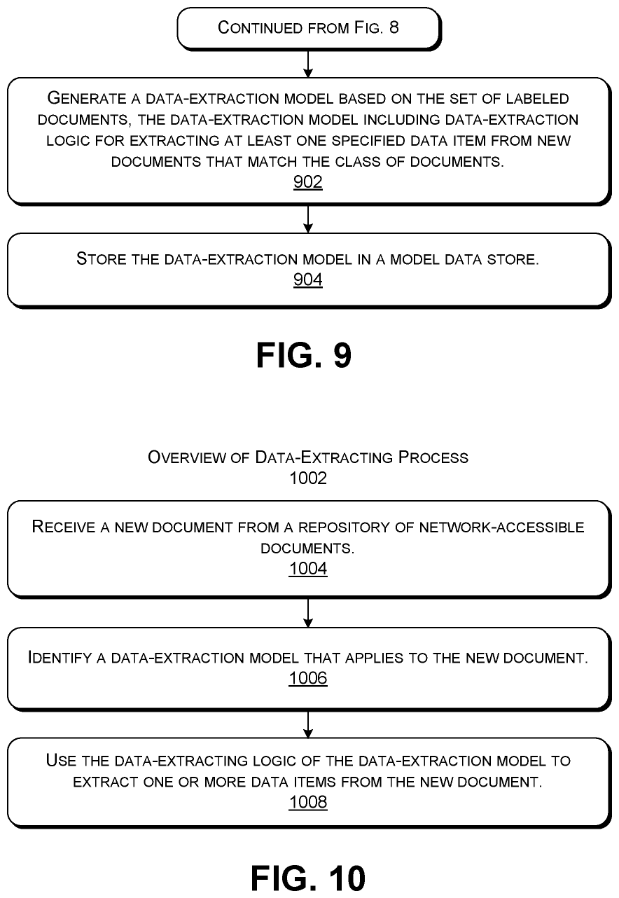

FIGS. 8 and 9 together show an overview of a model-generating process 802 performed by the computing environment 102 of FIG. 1. In block 804, the document-sampling system 108 provides a set S₁ of sample documents from the repository 104 of network-accessible documents (e.g., markup-language documents) that match a filter pattern, the set S₁ of sample documents being associated with a class of network-accessible documents. A number of network-accessible documents in the set S₁ of sample documents is less that a total number of network-accessible documents in the repository 104 that match the filter pattern. In block 806, the document-sampling system 108 stores the set of sample documents in a sample data store 120. In block 808, the labeling component 122 uses a machine-trained labeling model 602 to apply labels to the set S₁ of sample documents, to provide a set L₁ of labeled documents. A label added to a given sample document identifies a type of data item that is present in the given sample document and a location of the data item in the given sample document. In block 810, the labeling component 122 stores the set L₁ of labeled documents in a labeled-document data store 124.

Advancing to FIG. 9, block 902, the model-generating component 126 generates a data-extraction model 302 based on the set L₁ of labeled documents. The data-extraction model 302 includes data-extracting logic 308 for extracting at least one specified data item from new documents that match the class of documents. In block 904, the model-generating component 126 stores the data-extraction model in a model data store 128. The data-extraction model incorporates knowledge imparted by the machine-trained labeling model 602 via the set of labeled documents, but consumes fewer computing resources (e.g., processor resources, memory resources, etc.) than the machine-trained labeling model 602.

FIG. 10 shows a data-extracting process 1002 performed by the computing environment 102 of FIG. 1. In block 1004, the data-extracting component 130 receives a new document from the repository 104 of network-accessible documents. In block 1006, the data-extracting component 130 identifies a data-extraction model 302 that applies to the new document. In block 1008, the data-extracting component 130 uses the data-extracting logic 308 of the data-extraction model 302 to extract one or more data items from the new document.

C. Representative Computing Device

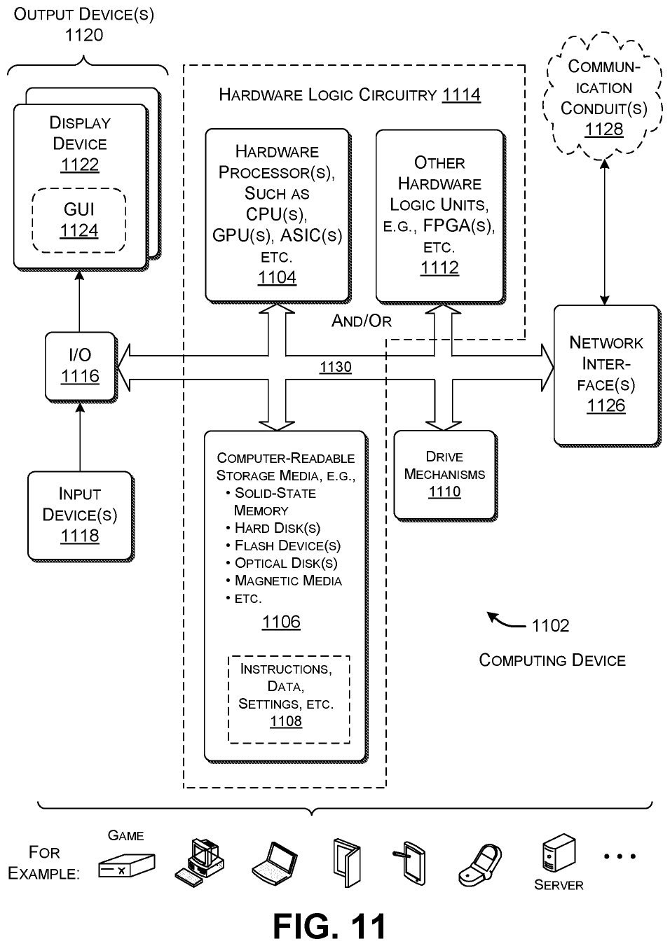

FIG. 11 shows a computing device 1102 that can be used to implement any aspect of the mechanisms set forth in the above-described figures. For instance, with reference to FIG. 3, the type of computing device 1102 shown in FIG. 11 can be used to implement any server, any user computing device, etc. In all cases, the computing device 1102 represents a physical and tangible processing mechanism.

The computing device 1102 can include one or more hardware processors 1104. The hardware processor(s) 1104 can include, without limitation, one or more Central Processing Units (CPUs), and/or one or more Graphics Processing Units (GPUs), and/or one or more Application Specific Integrated Circuits (ASICs), etc. More generally, any hardware processor can correspond to a general-purpose processing unit or an application-specific processor unit.

The computing device 1102 can also include computer-readable storage media 1106, corresponding to one or more computer-readable media hardware units. The computer-readable storage media 1106 retains any kind of information 1108, such as machine-readable instructions, settings, data, etc. Without limitation, for instance, the computer-readable storage media 1106 may include one or more solid-state devices, one or more magnetic hard disks, one or more optical disks, magnetic tape, and so on. Any instance of the computer-readable storage media 1106 can use any technology for storing and retrieving information. Further, any instance of the computer-readable storage media 1106 may represent a fixed or removable unit of the computing device 1102. Further, any instance of the computer-readable storage media 1106 may provide volatile or non-volatile retention of information.

The computing device 1102 can utilize any instance of the computer-readable storage media 1106 in different ways. For example, any instance of the computer-readable storage media 1106 may represent a hardware memory unit (such as Random Access Memory (RAM)) for storing transient information during execution of a program by the computing device 1102, and/or a hardware storage unit (such as a hard disk) for retaining/archiving information on a more permanent basis. In the latter case, the computing device 1102 also includes one or more drive mechanisms 1110 (such as a hard drive mechanism) for storing and retrieving information from an instance of the computer-readable storage media 1106.

The computing device 1102 may perform any of the functions described above when the hardware processor(s) 1104 carry out computer-readable instructions stored in any instance of the computer-readable storage media 1106. For instance, the computing device 1102 may carry out computer-readable instructions to perform each block of the processes described in Section B.

Alternatively, or in addition, the computing device 1102 may rely on one or more other hardware logic units 1112 to perform operations using a task-specific collection of logic gates. For instance, the hardware logic unit(s) 1112 may include a fixed configuration of hardware logic gates, e.g., that are created and set at the time of manufacture, and thereafter unalterable. Alternatively, or in addition, the other hardware logic unit(s) 1112 may include a collection of programmable hardware logic gates that can be set to perform different application-specific tasks. The latter category of devices includes, but is not limited to Programmable Array Logic Devices (PALs), Generic Array Logic Devices (GALs), Complex Programmable Logic Devices (CPLDs), Field-Programmable Gate Arrays (FPGAs), etc.

FIG. 11 generally indicates that hardware logic circuitry 1114 includes any combination of the hardware processor(s) 1104, the computer-readable storage media 1106, and/or the other hardware logic unit(s) 1112. That is, the computing device 1102 can employ any combination of the hardware processor(s) 1104 that execute machine-readable instructions provided in the computer-readable storage media 1106, and/or one or more other hardware logic unit(s) 1112 that perform operations using a fixed and/or programmable collection of hardware logic gates. More generally stated, the hardware logic circuitry 1114 corresponds to one or more hardware logic units of any type(s) that perform operations based on logic stored in and/or otherwise embodied in the hardware logic unit(s).

In some cases (e.g., in the case in which the computing device 1102 represents a user computing device), the computing device 1102 also includes an input/output interface 1116 for receiving various inputs (via input devices 1118), and for providing various outputs (via output devices 1120). Illustrative input devices include a keyboard device, a mouse input device, a touchscreen input device, a digitizing pad, one or more static image cameras, one or more video cameras, one or more depth camera systems, one or more microphones, a voice recognition mechanism, any movement detection mechanisms (e.g., accelerometers, gyroscopes, etc.), and so on. One particular output mechanism may include a display device 1122 and an associated graphical user interface presentation (GUI) 1124. The display device 1122 may correspond to a liquid crystal display device, a light-emitting diode display (LED) device, a cathode ray tube device, a projection mechanism, etc. Other output devices include a printer, one or more speakers, a haptic output mechanism, an archival mechanism (for storing output information), and so on. The computing device 1102 can also include one or more network interfaces 1126 for exchanging data with other devices via one or more communication conduits 1128. One or more communication buses 1130 communicatively couple the above-described units together.

The communication conduit(s) 1128 can be implemented in any manner, e.g., by a local area computer network, a wide area computer network (e.g., the Internet), point-to-point connections, etc., or any combination thereof. The communication conduit(s) 1128 can include any combination of hardwired links, wireless links, routers, gateway functionality, name servers, etc., governed by any protocol or combination of protocols.

FIG. 11 shows the computing device 1102 as being composed of a discrete collection of separate units. In some cases, the collection of units may correspond to discrete hardware units provided in a computing device chassis having any form factor. FIG. 11 shows illustrative form factors in its bottom portion. In other cases, the computing device 1102 can include a hardware logic unit that integrates the functions of two or more of the units shown in FIG. 1. For instance, the computing device 1102 can include a system on a chip (SoC or SOC), corresponding to an integrated circuit that combines the functions of two or more of the units shown in FIG. 11.

The following summary provides a non-exhaustive set of illustrative aspects of the technology set forth herein.

According to a first example, one or more computing devices are described for processing network-accessible documents obtained from a wide-area network. The computing device(s) include hardware logic circuitry, which, in turn, includes: (a) one or more hardware processors that perform operations by executing machine-readable instructions stored in a memory, and/or (b) one or more other hardware logic units that perform the operations using a task-specific collection of logic gates. The operations include: providing a set of sample documents from a repository of network-accessible markup-language documents that match a filter pattern, the set of sample documents being associated with a class of network-accessible markup-language documents, a number of markup-language network-accessible documents in the set of sample documents being less that a total number of markup-language network-accessible documents in the repository that match the filter pattern; storing the set of sample documents in a sample-document data store; using a machine-trained labeling model to apply labels to the set of sample documents, to provide a set of labeled documents, a label added to a given sample document identifying a type of data item that is present in the given sample document and a location of the data item in the given sample document; storing the set of labeled documents in a labeled-document data store; generating a data-extraction model based on the set of labeled documents, the data-extraction model including data-extracting logic for extracting at least one specified data item from new documents that match the class of documents; and storing the data-extraction model in a model data store.

According to a second example, the hardware logic circuitry performs the operations of providing, using, and generating for at least one other class of markup-language network-accessible documents, to overall provide plural data-extraction models associated with respective classes of markup-language network-accessible documents.

According to a third example, the hardware logic circuitry further performs operations of: generating plural filter patterns associated with different respective classes of markup-language network-accessible documents; and storing the plural filter patterns in a filter data store. The operation of providing uses the plural filter patterns to produce plural sets of sample documents associated with the respective classes of markup-language network-accessible documents.

According to a fourth example, the operation of providing extracts markup-language network-accessible documents having URLs that match the filter pattern.

According to a fifth example, the given sample document expresses content as a collection of nodes arranged in a tree data structure.

According to a sixth example, the given sample document is an HTML, document.

According to a seventh example, the operation of generating identifies at least one pattern in the set of labeled documents that satisfies a prescribed statistical condition.

According to an eighth example, the data-extraction model incorporates knowledge imparted by the machine-trained labeling model via the set of labeled documents, but the data-extraction model consumes fewer computing resources than the machine-trained labeling model.

According to a ninth example, the hardware logic circuitry is further configured to perform a data-extracting operation, the data-extracting operation including: receiving a new document from the repository of markup-language network-accessible documents, the new document not being a member of the set of sample documents; determining that the data-extraction model applies to the new document; and using the data-extracting logic of the data-extraction model to extract one or more data items from the new document.

According to a tenth example, related to the ninth example, the operation of determining tests whether a URL associated with the new document matches the filter pattern.

According to an eleventh example, a computer-implemented method is for processing network-accessible documents obtained from a wide-area network. The method includes: receiving a new document from a repository of markup-language network-accessible documents; identifying a data-extraction model that applies to the new document; and using the data-extraction model to extract one or more data items from the new document. The data-extraction model is produced, in advance of the operation of receiving, in a model-generating process that includes: providing a set of sample documents from the repository of markup-language network-accessible documents that match a filter pattern, the set of sample documents being associated with a class of markup-language network-accessible documents, a number of markup-language network-accessible documents in the set of sample documents being less that a total number of markup-language network-accessible documents in the repository that match the filter pattern; storing the set of sample documents in a sample-document data store; using a machine-trained labeling model to apply labels to the set of sample documents, to provide a set of labeled documents, a label added to a given sample document identifying a type of data item that is present in the given sample document and a location of the data item in the given sample document; storing the set of labeled documents in a labeled-document data store; generating the data-extraction model based on the set of labeled documents, the data-extraction model including data-extracting logic for extracting at least one specified data item from new documents that match the class of documents; and storing the data-extraction model in a model data store.

According to a twelfth example, related to the eleventh example, the model-generating process further includes performing the operations of providing, using, and generating of the model-generating process for at least one other class of markup-language network-accessible documents, to overall provide plural data-extraction models associated with respective classes of markup-language network-accessible documents.

According to a thirteenth example, relating to the eleventh example, the operation of identifying tests whether a URL associated with the new document matches the filter pattern.

According to a fourteenth example, relating to the eleventh example, the operation of providing extracts markup-language network-accessible documents having URLs that match the filter pattern.

According to a fifteenth example, relating to the eleven example, the given sample document expresses content as a collection of elements arranged in a tree data structure.

According to a sixteenth example, relating to the eleventh example, the operation of generating identifies least one pattern in the set of labeled documents that satisfies a prescribed statistical condition.

According to a seventeenth example, relating to the eleventh example, the data-extraction model incorporates knowledge imparted by the machine-trained labeling model via the set of labeled documents, but the data-extraction model consumes fewer computing resources than the machine-trained labeling model.

According to an eighteenth example, a computer-readable storage medium is described for storing computer-readable instructions. The computer-readable instructions, when executed by one or more hardware processors, perform a method that that includes a model-generating process and a data-extracting process. The model-generating process includes: providing a set of sample documents from a repository of markup-language network-accessible documents that match a filter pattern, the set of sample documents being associated with a class of markup-language network-accessible documents, a number of markup-language network-accessible documents in the set of sample documents being less that a total number of markup-language network-accessible documents in the repository that match the filter pattern; storing the set of sample documents in a sample-document data store; using a machine-trained labeling model to apply labels to the set of sample documents, to provide a set of labeled documents, a label added to a given sample document identifying a type of data item that is present in the given sample document and a location of the data item in the given sample document; storing the set of labeled documents in a labeled-document data store; generating a data-extraction model based on the set of labeled documents by identifying least one pattern in the set of labeled documents that satisfies a prescribed statistical condition, the data-extraction model including data-extracting logic for extracting at least one specified data item from new documents that match the class of documents; and storing the data-extraction model in a model data store. The data-extracting process includes: receiving a new document from the repository of markup-language network-accessible documents, the new document not being a member of the set of sample documents; determining that the data-extraction model applies to the new document; and using the data-extraction model to extract one or more data items from the new document.

According to a nineteenth example, relating to the eighteenth example, the model-generating process further includes performing the operations of providing, using, and generating of the model-generating process for at least one other class of markup-language network-accessible documents, to overall provide plural data-extraction models associated with respective classes of markup-language network-accessible documents.

According to a twentieth example, relating to the eighteenth example, the operation of determining tests whether a URL associated with the new document matches the filter pattern.

A twenty-first example corresponds to any combination (e.g., any logically consistent permutation or subset) of the above-referenced first through twentieth examples.

A twenty-second example corresponds to any method counterpart, device counterpart, system counterpart, means-plus-function counterpart, computer-readable storage medium counterpart, data structure counterpart, article of manufacture counterpart, graphical user interface presentation counterpart, etc. associated with the first through twenty-first examples.

In closing, the functionality described herein can employ various mechanisms to ensure that any user data is handled in a manner that conforms to applicable laws, social norms, and the expectations and preferences of individual users. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computing devices for processing network-accessible documents obtained from a wide-area network, comprising:
hardware logic circuitry, the hardware logic circuitry including: (a) one or more hardware processors that perform operations by executing machine-readable instructions stored in a memory, and/or (b) one or more other hardware logic units that perform the operations using a task-specific collection of logic gates, the operations including:
providing a set of sample documents from a repository of network-accessible markup-language documents that match a filter pattern, the set of sample documents being associated with a class of network-accessible markup-language documents, a number of markup-language network-accessible documents in the set of sample documents being less that a total number of markup-language network-accessible documents in the repository that match the filter pattern;
storing the set of sample documents in a sample-document data store;
using a machine-trained labeling model to apply labels to the set of sample documents, to provide a set of labeled documents, a label added to a given sample document identifying a type of data item that is present in the given sample document and a location of the data item in the given sample document;
storing the set of labeled documents in a labeled-document data store;
generating a data-extraction model based on the set of labeled documents, the data-extraction model including data-extracting logic for extracting at least one specified data item from new documents that match the class of documents; and
storing the data-extraction model in a model data store.

2. The one or more computing devices of claim 1, wherein the hardware logic circuitry performs said providing, using, and generating for at least one other class of markup-language network-accessible documents, to overall provide plural data-extraction models associated with respective classes of markup-language network-accessible documents.

3. The one or more computing devices of claim 1, wherein the hardware logic circuitry further performs operations of:
generating plural filter patterns associated with different respective classes of markup-language network-accessible documents; and
storing the plural filter patterns in a filter data store,
said providing using the plural filter patterns to produce plural sets of sample documents associated with the respective classes of markup-language network-accessible documents.

4. The one or more computing devices of claim 1, wherein said providing extracts markup-language network-accessible documents having URLs that match the filter pattern.

5. The one or more computing devices of claim 1, wherein the given sample document expresses content as a collection of nodes arranged in a tree data structure.

6. The one or more computing devices of claim 1, wherein the given sample document is an HTML document.

7. The one or more computing devices of claim 1, wherein said generating identifies at least one pattern in the set of labeled documents that satisfies a prescribed statistical condition.

8. The one or more computing devices of claim 1, wherein the data-extraction model incorporates knowledge imparted by the machine-trained labeling model via the set of labeled documents, but the data-extraction model consumes fewer computing resources than the machine-trained labeling model.

9. The one or more computing devices of claim 1, wherein the hardware logic circuitry is further configured to perform a data-extracting operation, the data-extracting operation including:
receiving a new document from the repository of markup-language network-accessible documents, the new document not being a member of the set of sample documents;
determining that the data-extraction model applies to the new document; and
using the data-extracting logic of the data-extraction model to extract one or more data items from the new document.

10. The one or more computing devices of claim 9, wherein said determining tests whether a URL associated with the new document matches the filter pattern.

11. A computer-implemented method for processing network-accessible documents obtained from a wide-area network, comprising:
receiving a new document from a repository of markup-language network-accessible documents;
identifying a data-extraction model that applies to the new document; and
using the data-extraction model to extract one or more data items from the new document,
the data-extraction model being produced, in advance of said receiving, in a model-generating process that includes:
providing a set of sample documents from the repository of markup-language network-accessible documents that match a filter pattern, the set of sample documents being associated with a class of markup-language network-accessible documents, a number of markup-language network-accessible documents in the set of sample documents being less that a total number of markup-language network-accessible documents in the repository that match the filter pattern;
storing the set of sample documents in a sample-document data store;
using a machine-trained labeling model to apply labels to the set of sample documents, to provide a set of labeled documents, a label added to a given sample document identifying a type of data item that is present in the given sample document and a location of the data item in the given sample document;
storing the set of labeled documents in a labeled-document data store;
generating the data-extraction model based on the set of labeled documents, the data-extraction model including data-extracting logic for extracting at least one specified data item from new documents that match the class of documents; and
storing the data-extraction model in a model data store.

12. The method of claim 11, wherein the model-generating process further includes performing said providing, using, and generating of the model-generating process for at least one other class of markup-language network-accessible documents, to overall provide plural data-extraction models associated with respective classes of markup-language network-accessible documents.

13. The method of claim 11, wherein said identifying tests whether a URL associated with the new document matches the filter pattern.

14. The method of claim 11, wherein said providing extracts markup-language network-accessible documents having URLs that match the filter pattern.

15. The method of claim 11, wherein the given sample document expresses content as a collection of elements arranged in a tree data structure.

16. The method of claim 11, wherein said generating identifies least one pattern in the set of labeled documents that satisfies a prescribed statistical condition.

17. The method of claim 11, wherein the data-extraction model incorporates knowledge imparted by the machine-trained labeling model via the set of labeled documents, but the data-extraction model consumes fewer computing resources than the machine-trained labeling model.

18. A computer-readable storage medium for storing computer-readable instructions, the computer-readable instructions, when executed by one or more hardware processors, performing a method that comprises:
in a model-generating process:
providing a set of sample documents from a repository of markup-language network-accessible documents that match a filter pattern, the set of sample documents being associated with a class of markup-language network-accessible documents, a number of markup-language network-accessible documents in the set of sample documents being less that a total number of markup-language network-accessible documents in the repository that match the filter pattern;
storing the set of sample documents in a sample-document data store;
using a machine-trained labeling model to apply labels to the set of sample documents, to provide a set of labeled documents, a label added to a given sample document identifying a type of data item that is present in the given sample document and a location of the data item in the given sample document;
storing the set of labeled documents in a labeled-document data store;
generating a data-extraction model based on the set of labeled documents by identifying least one pattern in the set of labeled documents that satisfies a prescribed statistical condition, the data-extraction model including data-extracting logic for extracting at least one specified data item from new documents that match the class of documents; and
storing the data-extraction model in a model data store; and
in a data-extracting process:
receiving a new document from the repository of markup-language network-accessible documents, the new document not being a member of the set of sample documents;
determining that the data-extraction model applies to the new document; and
using the data-extraction model to extract one or more data items from the new document.

19. The computer-readable storage medium of claim 18, wherein the model-generating process further includes performing said providing, using, and generating of the model-generating process for at least one other class of markup-language network-accessible documents, to overall provide plural data-extraction models associated with respective classes of markup-language network-accessible documents.

20. The computer-readable storage medium of claim 18, wherein said determining tests whether a URL associated with the new document matches the filter pattern.
